(19) United States
(12) Patent Application Publication
(10) Pub. No.: US 2013/0335205 A1
(43) Pub. Date: Dec. 19, 2013

(54) Combination Waterproof Paddle Controller and Waterproof Music Device

(71) Applicant: Madeleine Willner, Lorton, VA (US)

(72) Inventor: Madeleine Willner, Lorton, VA (US)

(21) Appl. No.: 13/910,353

(22) Filed: Jun. 5, 2013

Related U.S. Application Data
(60) Provisional application No. 61/657,020, filed on Jun. 7, 2012.

(51) Int. Cl. G08C 19/16

(52) U.S. Cl. CPC G08C 19/16
USPC 340/12.22

(57) ABSTRACT

Hand held water propulsion tools, such as paddles and oars, are equipped with a waterproof compartment for a consumer electronic device, such as a MP3 player or a smartphone. Also built into the propulsion tool are speakers, a microphone, and electronic keys, to listen to music, talk on the phone, and control the device secured in the waterproof compartment. Only the fewest, most optimal buttons needed to control an MP3 player or smartphone are built into the propulsion tool to minimize the learning curve by reducing complexity and optimizing ease-of-use. Paddle boarders and boaters can use the present invention to enhance their enjoyment of, and productivity while using, floating boards and small boats.

### TECHNICAL FIELD

The field of invention relates to small boat and floating boards propulsion and waterproof controls, specifically to hand held paddles, oars, and handles. The field of invention also relates to waterproof microphones and speakers. The field of invention also relates to floating water-related devices, and more particularly to devices equipped with radios, music players, and mobile phones for use with water-related activities.

### BACKGROUND OF THE INVENTION

There are many prior sound devices for enjoying water-related activities on a floatation device. There are also many prior art devices for listening to music, news, etc. A waterproof radio and/or music device has its obvious advantage in that it does not get ruined during water-related activities. It can be problematic, however, to carry a waterproof sound device on your person while participating in such activities. Constructing water equipment with a waterproof music device attachment, therefore, is much more practical and desirable. Furthermore, a paddle, oar, etc., that is included to be used as the controller of said device is also desirable. The included paddle control is also to include a waterproof microphone and speakers if preferred. OBJECTS AND ADVANTAGES

Many times it is desirable to both paddle and listen to music while on a stand up paddle (“SUP”) board, kayak, canoe, etc. The relatively new sport of paddle boarding for example, with its growing popularity, would definitely benefit from this added technology. Paddleboarders may be out on the water to relax or exercise. In either case, enjoyment can be further enhanced with the addition of waterproof radio or a plug-in for a mobile phone or a music player, such as an iPod (produced by Apple Computer, Inc., it is currently the most popular, portable digital media player in the United States). The described invention is a waterproof controller which differs from all others because it provides a more convenient way to control your music or channel choice than by having to bend down or shift your weight, which risks the chance of losing your balance and falling into the water. The paddle that comes with the board is used to not only propel the floatation device, but also to act as the controller of an external music device, for example the board's built in music device or music connection device.

Patent Pub. No. U.S. 2011/0212691 A1 explains how waterproof controls on paddles or oars. The present invention differs from the patented invention because it is simplified and optimized for listening to music or communicating over a mobile phone; it includes only the most necessary and optimal buttons applied to control a music player or mobile phone. Furthermore, this paddle includes a waterproof microphone and waterproof speakers. If the connected device is a mobile phone, for example, then the user will be able to answer or ignore an incoming call by voice activation, the press of a button located on the paddle, oar, etc., or other preferred method. If the user chooses to answer the call, he or she can speak through the microphone and listen through the speakers in the paddle.

### DISCLOSURE OF THE INVENTION

The present invention provides a paddle, oar, etc. for use with water related activities that has the capability of controlling an external music player or mobile phone. It also provides a way to communicate through the built-in waterproof microphone and speakers. The controls, microphone, and speakers are waterproofed, the well-known functionality and various constructions of which are commonly understood by those of ordinary skill in the art. The present invention also provides a SUP board, kayak, canoe, etc. for use with water related activies. The board, kayak, canoe, etc. provides a waterproof radio or music player or mobile phone connector and waterproof speakers which provide the capability of using all the functionality that a radio, music player, or mobile phone embodies. The related sound devices are made waterproof, the well-known functionality and various constructions of which are commonly understood by those of ordinary skill in the art.

The specific control buttons located on the paddle, oar, etc. and the positioning of same, along with the microphone and speaker positioning, are further explained in the description of the drawings below.

### DESCRIPTION OF DRAWINGS

This patent differs from Pub. No. U.S. 2011/0212691 A1 submitted by Dainuri Rott and Miles Hopkins (the “Rott-Hopkins Patent Application”) because this button layout is specifically for controlling a music player or mobile phone that would be attached to the paddle board, kayak, canoe, etc. Although the Rot-Hopkins Patent Application covers multiple positions and different types of controls for the oar, they most often refer to controlling motors on a paddleboard or controls for a tracking device. The button uses and positioning in the present patent are much more specific to controls for a music player or mobile phone including play, pause, volume, etc. The current patent also refers to a lock button, which is crucial in case of unintentional activation. The present invention is further differentiated from the Rott-Hopkins Patent Application by the microphone and speakers incorporated into the handheld propulsion device.

FIG. 1 is a perspective front view of a paddleboard with a waterproof case for a music player (1) and waterproof speakers (2).

FIG. 2 is a side view of a paddleboard according to the present invention. This view shows that nothing is protruding in an abnormal manner to the current, preferred design of SUP boards.

FIG. 3 is a front view of a SUP board according to the present invention.

FIG. 4 is a front view of a paddle for a paddleboard that is equipped with waterproof controllers (3).

FIG. 5 is a front perspective view of the paddle equipped with waterproof controls (3) according to the present invention.

FIG. 6 is a side view of a paddle with waterproof control buttons (3) according to the present invention.

FIG. 7 is a close up, front view of the specific buttons that would be on the elongated portion of the oar or paddle. As shown, there are three buttons. The middle, circular button (4) is pressed with a short push to either Play or Pause sound. When pressed longer, it is used to Power On or Power Off the device.

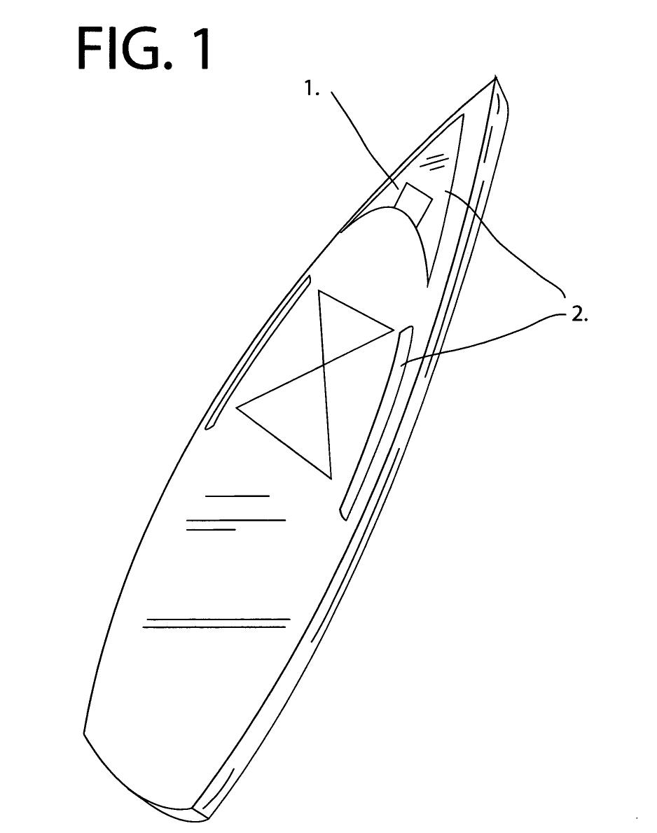

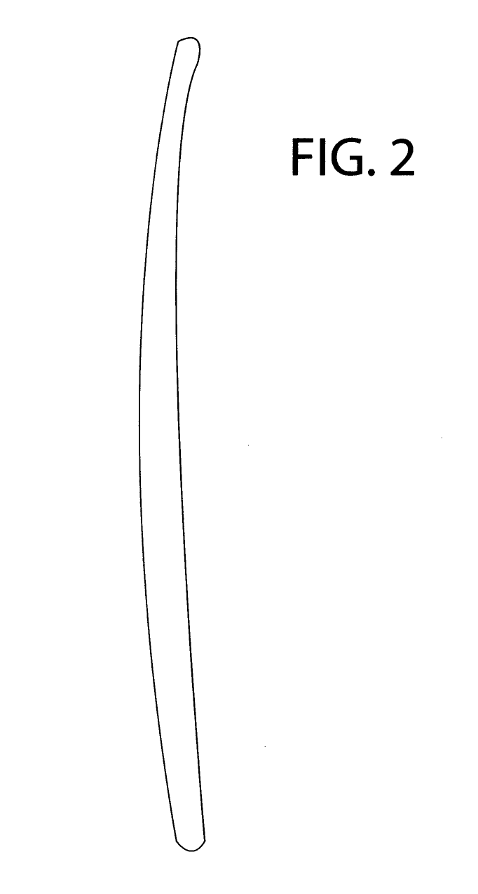

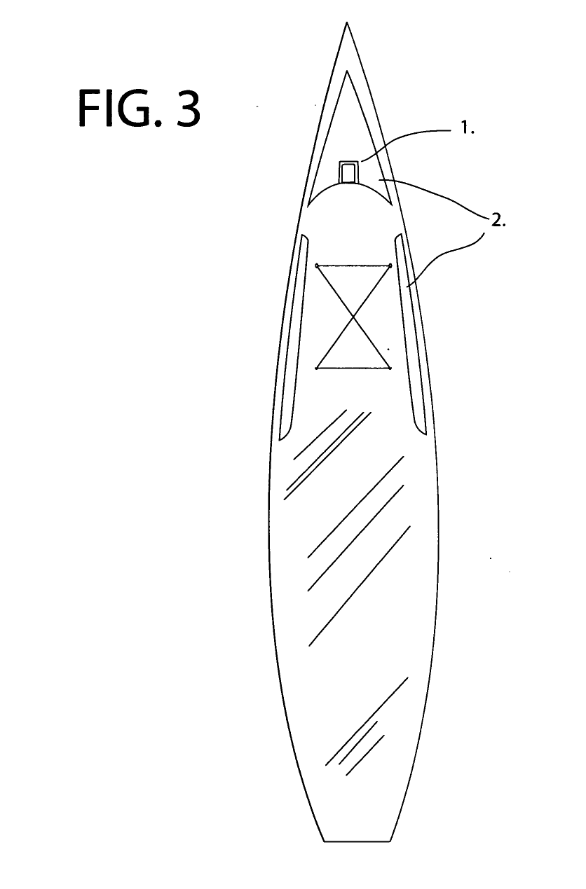

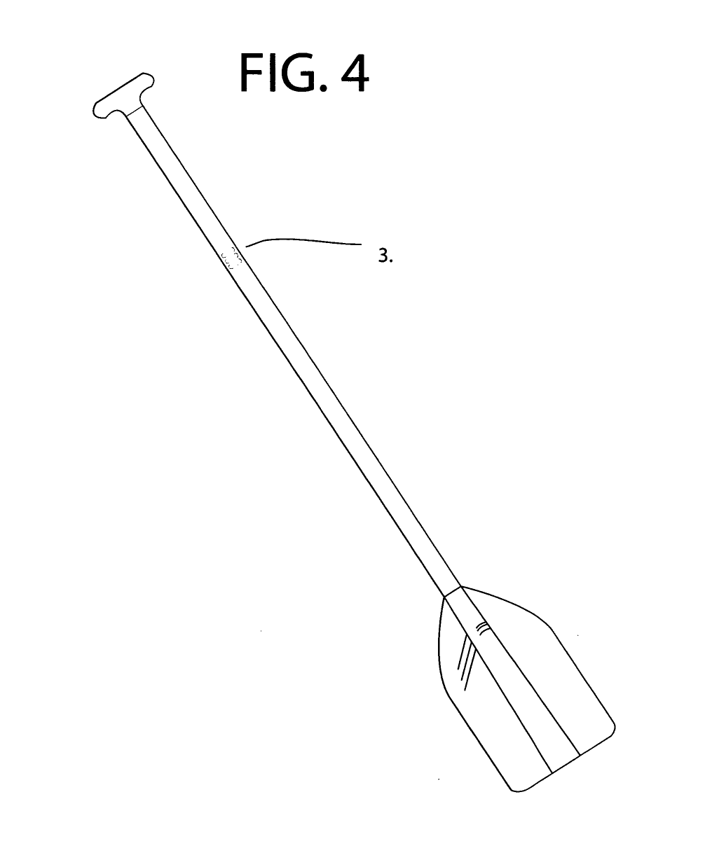

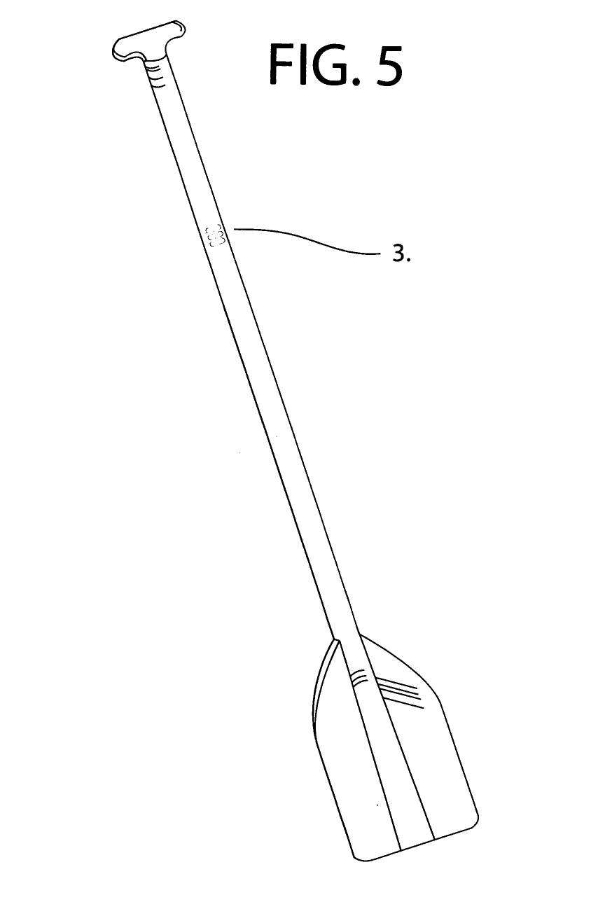

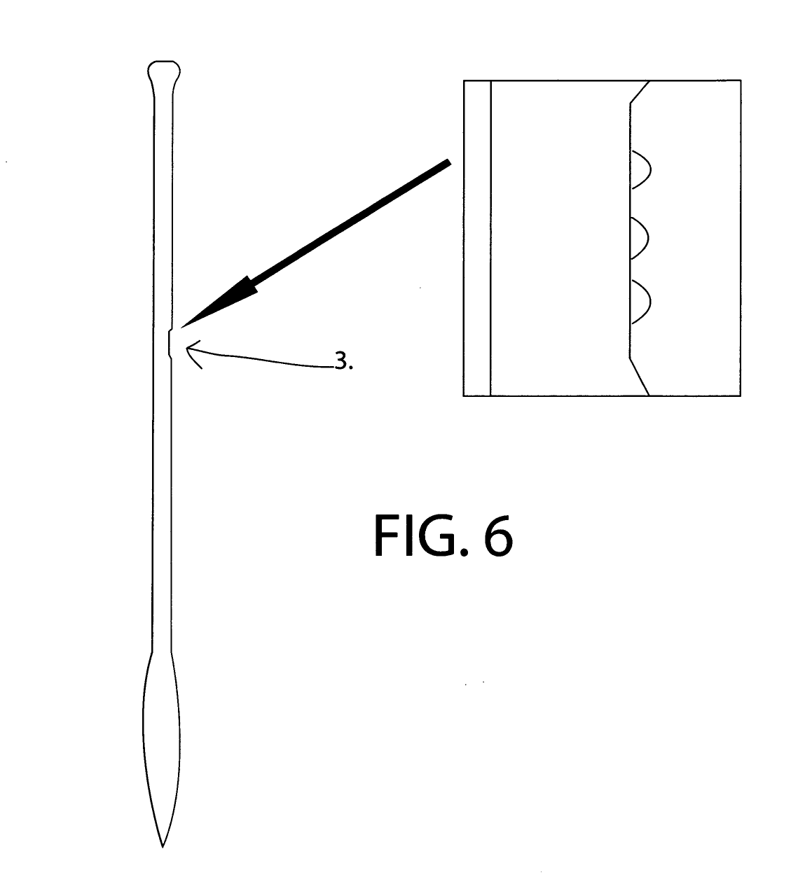

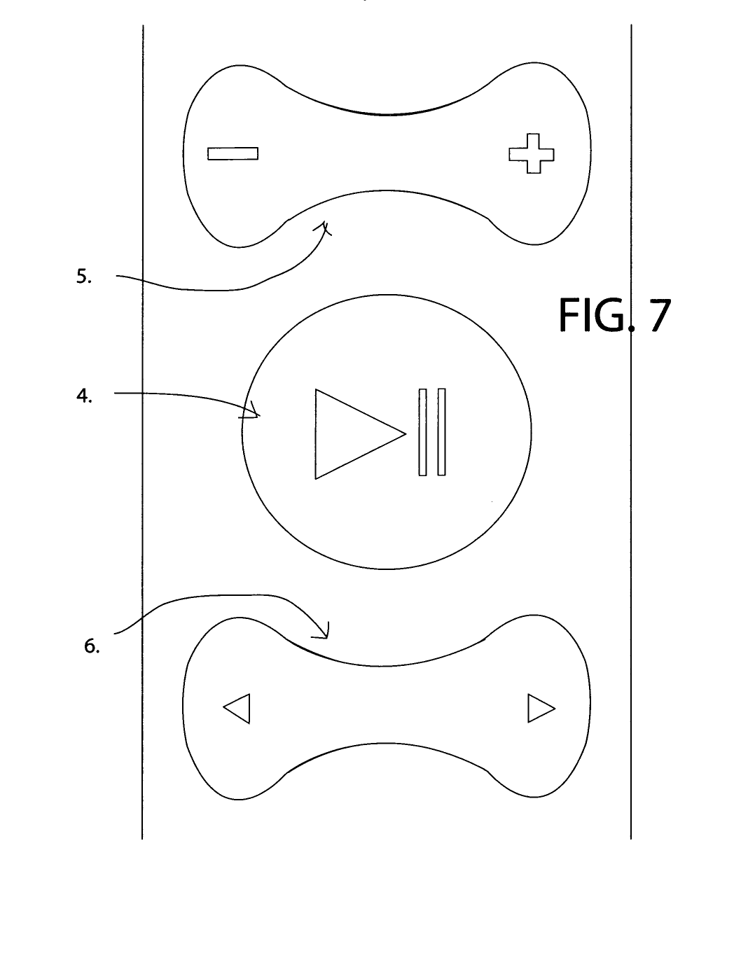

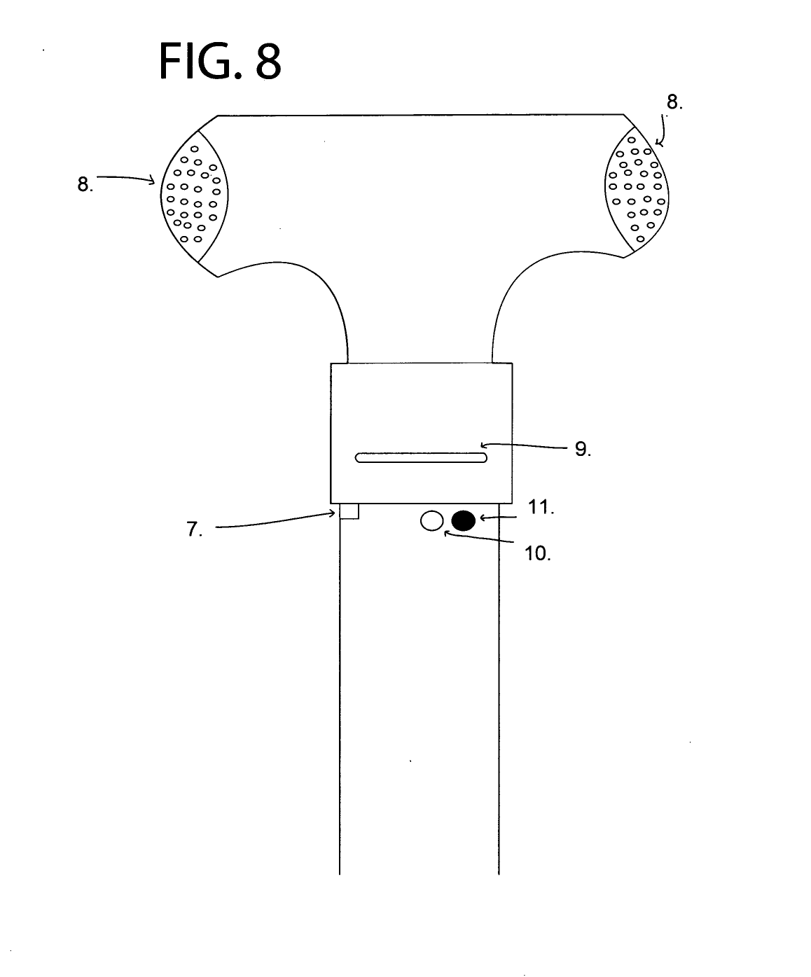

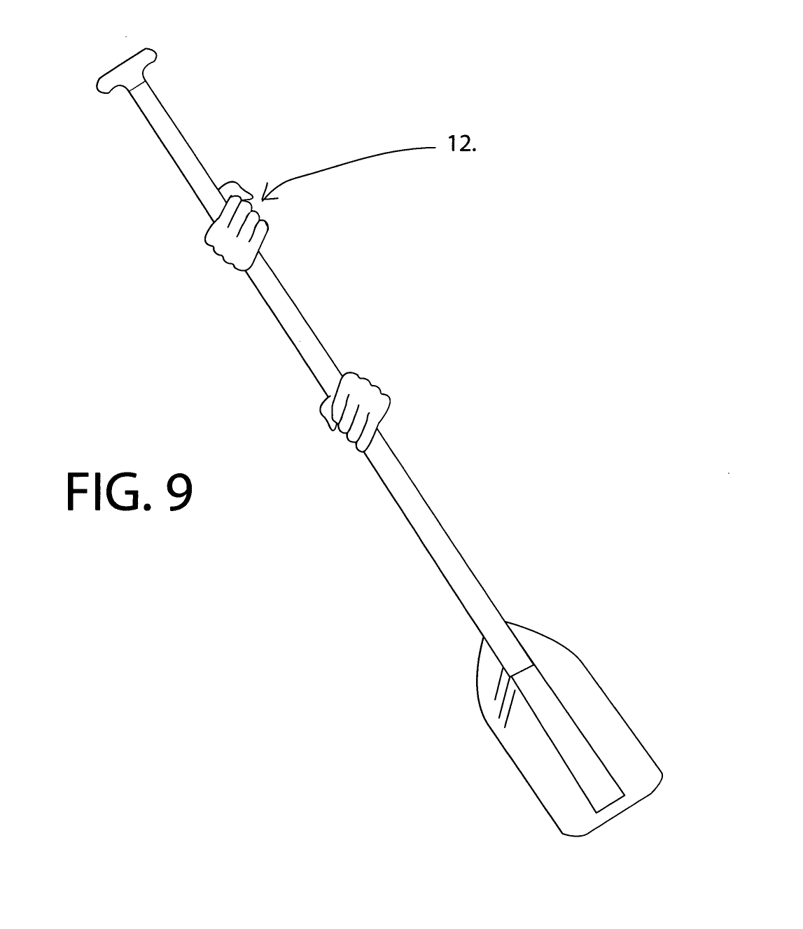

The top, elongated, horizontal button (5) is pressed to adjust volume. The bottom, elongated, horizontal button (6) is pressed to change station or song choice.

The specification of these buttons are important and patentable against the referred patent application because they are located in the most strategic manner on the paddle to enhance maximum functionality of any radio, music player, or mobile phone with the least number of buttons and the simplest key configuration and also in the most convenient position to reach while continuing to use the paddle, but unlikely to be hit or grasped unintentionally.

FIG. 8 is a close-up picture of a Lock button (7) on the top handle of the paddle. The addition of this button would allow the user to only use the above-specified buttons if they meant to, and not unintentionally. By sliding the dial one way, the user would be locking the buttons to prevent them from adjusting their sound preferences unintentionally. By sliding the dial the other way, the user can unlock the controls so they can then be adjusted purposely.

FIG. 8 is also a graphic depiction of the preferred embodiment of the waterproof speakers (8) and microphone (9) that are built into the paddle. The speakers are in the handle of the paddle because that is the closest part of the paddle to the user's ears. With the speakers here, if the user answers a phone call, it is more private in the sense that not everyone around the user can hear what is being said to the user. The speakers are strategically placed on either end of the handle so the user's hand does not block the sound coming from the speakers.

The microphone is located just beneath the paddle's handle; where the user's hand will not cover it but the user can speak into it easily.

This added technology to a water activity such as paddle boarding does not only enhance convenience, but also improves safety. If the user needs to contact anyone for help, they can easily do so with this technology.

Button 10 is an “answer” button while 11 is an “ignore” button. The purpose of these buttons is to make it simple to answer or ignore an incoming call if you have your mobile phone in connection with the paddle, oar, etc. controls.

FIG. 9 depicts the location of the buttons relative to how a person would hold the paddle when in use. They are positioned to be manipulated without looking at them and positioned within convenient reach of an operator's normal hand position on the implement. The users hand that is normally placed on the top handle of the paddle or oar would only need to shift downwards slightly into position 12 to reach the controls. The buttons of the present invention differ from Patent Application Pub. No. U.S. 2011/0212691 A1 because they are specific to the control of a music player or mobile phone. The present invention consists of only those buttons needed to generate the most important commands for a music player or mobile phone while keeping the controls extremely simple and convenient to use.

What is claimed is:

1. A handheld propulsion device such as a paddle, oar, or ski pole with a specific number of buttons incorporated in a strategic manner to enhance the maximum functionality of the device for control of electronic devices the objective being to provide the simplest most convenient method of control with the least number of buttons in a configuration promoting the minimum amount of a user's movement to actuate said buttons.

2. The handheld propulsion device in claim 1, further comprising three keys with multiple functionalities that correlate to controlling a mobile electronic music player or mobile phone between the natural positioning of each hand of a user of a handheld propulsion device such as a paddle or oar.

3. The handheld propulsion device in claim 1, where said keys are located between the handle of the paddle, oar etc., and the preferred position of the second hand on the rod of the paddle, oar, etc.

4. The handheld propulsion device in claim 1, further comprising one key that has the multiple functionalities when pressed to generate the following sound commands: Play, Pause, Power on, and Power off.

5. The handheld propulsion device in claim 1, further comprising, one key which generates commands to increase or decrease the sound volume.

6. The handheld propulsion device in claim 1, further comprising, one key which generates commands to change stations, channels, song choices, etc.

7. The handheld propulsion device in claim 1, further comprising one key which generates commands to Play, Pause, Power on and Power off a device's sound, one key of which generates commands to increase or decrease the volume of a device's sound, and one key of which generates commands to change stations, channels, song choices, etc.

8. The handheld propulsion device in claim 1, further comprising a lock button or dial which generates a command to lock or unlock the button functions that are set on the paddle, oar, etc. when the lock button is activated.

9. A handheld propulsion device such as a paddle, oar, or ski pole with a waterproof microphone incorporated into said device.

10. The handheld propulsion device in claim 9, further comprising waterproof speakers incorporated into said device.

11. The handheld propulsion device in claim 1, further comprising a floating vessel such as a paddleboard, kayak, canoe, or small boat which incorporates a waterproof enclosure for an electronic device.

12. The handheld propulsion device in claim 12, where said waterproof enclosure is for an electronic communication device such as a music player or mobile phone.
